(19) United States
(12) Patent Application Publication
(10) Pub. No.: US 2018/0051776 A1
(43) Pub. Date: Feb. 22, 2018

(54) GEARBOX

(71) Applicant: Siemens Aktiengesellschaft, Munchen (DE)

(72) Inventor: Arno Klein-Hitpass, Aachen (DE)

(73) Assignee: Siemens Aktiengesellschaft, Munchen (DE)

(21) Appl. No.: 15/680,682

(22) Filed: Aug. 18, 2017

(30) Foreign Application Priority Data
Aug. 19, 2016 (EP) 16184862.7

(51) Int. Cl. F16H 1/28; F16H 57/08

(52) U.S. Cl. CPC F16H 1/2845; F16H 57/08

(57) ABSTRACT

A gearbox includes a planetary stage having at least two planetary gear trains which are connected in parallel and flexibly coupled to one another. Each planetary gear train has individual components which are each defined by a torsional stiffness, with a power flow through the planetary gear trains being controlled by coordinating the torsional stiffness of the individual components of the planetary gear trains.

### CROSS-REFERENCES TO RELATED APPLICATIONS

This application claims the priority of European Patent Application, Serial No. 16184862.7, filed Aug. 19, 2016, pursuant to 35 U.S.C. 119(a)-(d), the content of which is incorporated herein by reference in its entirety as if fully set forth herein.

### BACKGROUND OF THE INVENTION

The invention relates to a gear box.

Large wind turbines are typically used in offshore installations and include a powertrain with a gearbox which must be able to reliably transmit very high torque. If the tooth mesh of a gear pair is insufficient for high torque, the concept of power splitting comes into play in which torque transmission takes place on several parallel paths through the gearbox such that a single transmission path has to transmit a lower torque than the total torque. A planetary gear train, in which several planetary gears simultaneously mesh with a ring gear and a sun gear, is a very common form of power splitting.

It would be desirable and advantageous to provide an improved gear box with improved power splitting in the gearbox.

### SUMMARY OF THE INVENTION

According to one aspect of the present invention, a gearbox includes a planetary stage including at least two planetary gear trains connected in parallel and flexibly coupled to one another, each planetary gear train having individual components which are each defined by a torsional stiffness, with a power flow through the planetary gear trains being controlled by coordinating the torsional stiffness of the individual components of the planetary gear trains.

In the description, the term “individual components” of the planetary gear trains primarily relates to hollow shafts of the sun gears, flexible planetary axles, flexible couplings, planet carriers, and secondarily planetary gears and ring gears.

Each individual component, i.e. each part, has a specific torsional stiffness. This can be determined analytically in the case of simple bodies such as hollow cylinders. Ultimately, however, the deformations of the individual components overlap in the overall system, i.e. the planetary gear train. The sun gear including its shaft is the softest element in the system, followed by the planet carrier. The ring gear fastened to the gearbox housing together with the gearbox housing forms the stiffest element.

Coordination of the stiffness advantageously is realized by using a numerical simulation which can represent the stiffness behavior of the overall system including its crossover influences sufficiently accurately. Using empirical numerical models, simple analytical formulas which reduce the complex numerical calculations in day-to-day life can be derived.

In terms of load distribution, a distinction must be drawn between two influencing variables. The primary basic stiffness of the individual components is superimposed by secondary stiffness influence parameters which are significantly determined by manufacturing variances. As long as the primary basic stiffness of an individual component dominates the secondary stiffness influence parameters in terms of the load distribution, the adjusted load distribution over the total operating time of the overall system is stable. In principle, an arbitrary load distribution can be adjusted, the respective gear teeth must be designed accordingly. Corresponding safety factors must be considered for the remaining error in the load distribution as a result of the secondary stiffness parameters.

The inspection of load distribution in operation is advantageously implemented by way of strain gauges on a suitable individual component, i.e. a suitable part, in both: load paths. Variations in load distribution can be offset by a stiffness modification of one or more individual components through mechanical removal of material.

The torsional stiffness of the individual components of the planetary gear trains can, for example, be adjusted to a desired value by varying wall thicknesses, axial lengths, diameters and the material of the individual components.

In the solution according to the invention, additional construction elements or components for adjusting power splitting in a gearbox are unnecessary; instead the torsional stiffness of the existing construction elements and components is used for sufficient control of the power flow by the planetary gear trains connected in parallel. The present invention therefore creates a simple method of transmitting significantly higher torque through a gearbox using traditional construction elements than previously.

Further advantageous features are set forth in the dependent claims, and may be combined with one another in any desired manner in order to achieve further advantages.

According to another advantageous feature of the present invention, the planetary stage can include a planet carrier, a planetary axle fastened in the planet carrier, at least two planetary gears mounted on the planetary axle for rotation independently of each other, ring gears meshing with the planetary gears in one-to-one correspondence, and sun gears meshing with the planetary gears in one-to-one correspondence, wherein each sun gear is arranged in a torque-proof manner on a sun gear shaft. It is advantageous that the structure of a traditional planetary gear train can be adopted.

According to another advantageous feature of the present invention, the at least two sun gear shafts corresponding to the sun gears may be arranged coaxially. it is advantageous that the torque of the two load paths can be routed to the output shaft of the gearbox in a space-saving and compact manner.

According to another advantageous feature of the present invention, the ring gears assigned to the at least two planetary gears can be rigidly interconnected. Advantageously, the ring gears can be made in one piece. It is advantageous that the structure of a traditional planetary gear train can be adopted.

According to another advantageous feature of the present invention, the at least two sun gear shafts corresponding to the sun gears can be flexibly coupled together. Advantageously a clutch can be provided for flexibly interconnecting the sun gear shafts. It is advantageous that the torsional stiffness of the two parallel power paths can be additionally coordinated by the gearbox.

According to another advantageous feature of the present invention, the planetary axle has a center, i.e. a central area of its longitudinal extension, which can be fastened in the planet carrier, with the at least two planetary gears being located on the planetary axle on both sides of the center. The planetary axle may advantageously be supported in three planes of the planet carrier, i.e. in one plane respectively at both ends of the planetary axle and in one plane in the central area of the planetary axle. Alternatively to the third plane, the planetary axle can also be kept in what is known as a “bogie plate.” Then the control of the torsional stiffness can be realized by means of the planetary axle and the sun shafts. Advantageously, use can be made of experiences with known so-called bogie plate, in which a planetary axle is supported in the center of a planet carrier, with planetary gears respectively arranged on the planetary axle on both sides of the support.

### BRIEF DESCRIPTION OF THE DRAWINGS

Other features and advantages of the present invention will be more readily apparent upon reading the following description of currently preferred exemplified embodiments of the invention with reference to the accompanying drawings, in which:

FIG. 1 shows schematically a longitudinal section of a first embodiment of a gearbox according to the present invention,

FIG. 2 shows schematically a longitudinal section of a second embodiment of a gearbox according to the present invention,

FIG. 3 shows schematically a longitudinal section of a third embodiment of a gearbox according to the present invention with a triplane planet carrier,

FIG. 4 shows schematically a longitudinal section of a fourth embodiment of a gearbox according to the present invention with a clutch, and

FIG. 5 shows schematically a longitudinal section of a fifth embodiment of a gearbox according to the present invention.

### DETAILED DESCRIPTION OF PREFERRED EMBODIMENTS

Throughout the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

In the figures, bearings such as roller or plain bearings are shown, as is customary in mechanical engineering, as rectangular boxes with a diagonal cross and characterized by reference numeral 20.

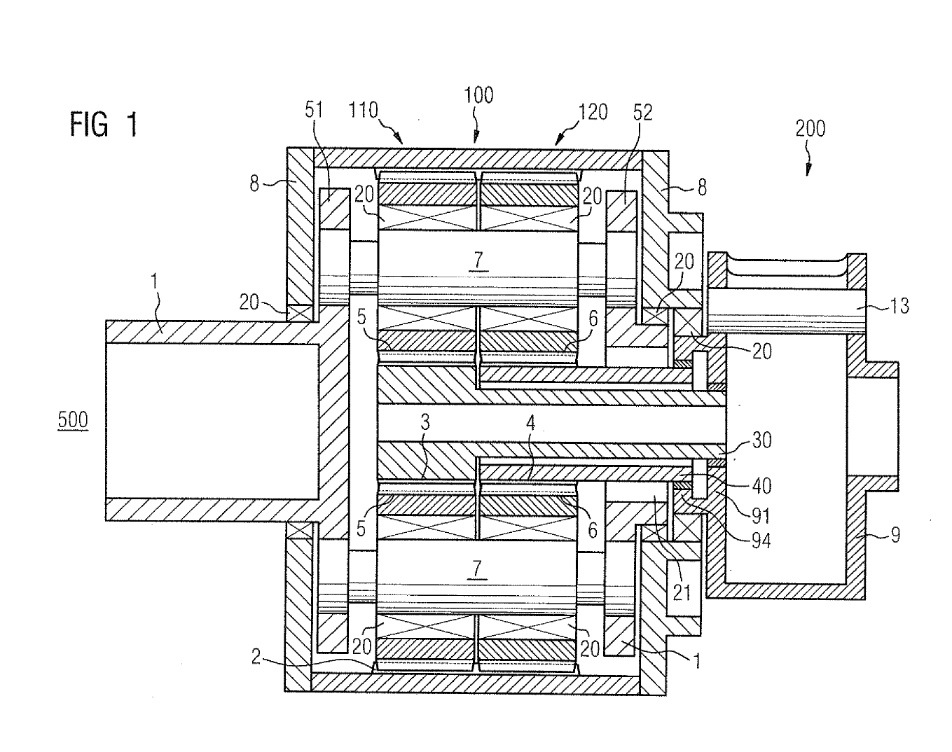

FIG. 1 shows a longitudinal section of a first embodiment of a gearbox according to the present invention. The gearbox includes a first planetary stage 100 and a second planetary stage 200 downstream of the first planetary stage 100.

The gearbox has a planet carrier 1 on the drive side of the first planetary stage 100 which is connected in a torque-proof manner by way of its hollow hub on the drive side to a rotor shaft 500, which is connected to a wind rotor of a wind turbine not shown here. The biplane planet carrier 1 of the first planetary stage 100 has a hollow hub on each of its two end faces or planes 51, 52, on which the bearings 20 are arranged to accommodate the planet carrier 1 in the housing 8.

The first planetary stage 100 comprises two planetary gear trains 110, 120 connected in parallel and arranged consecutively which produce power splitting. For this purpose, both planetary gear trains 110, 120 have the common planet carrier 1 of the first planetary stage 100 with common planetary axles 7 of the first planetary stage 100. The planetary gear trains 110, 120 each have a sun gear 3, 4 and planetary gears 5, 6 mounted so as to rotate in the planet carrier 1. Several common planetary axles 7 of the first planetary stage 100 are fastened in the common planet carrier 1 for rotatable mounting of the planetary gears 5, 6 of the two planetary gear trains 110, 120, on which roller or plain bearings 20 are mounted, which in turn support the planetary gears 5, 6.

Each of the planetary gears 5, 6 meshes with separate sun gears 3, 4, but with a common ring gear 2 of the first planetary stage 100. The separate sun gears 3, 4 are each housed in a torque-proof manner on coaxially rotatable sun gear hollow shafts 30, 40.

The sun gear hollow shafts 30, 40 are routed to a housing outlet 21 where they are rigidly connected to a planet carrier 9 of a second planetary stage 200 in which planetary axles 13 of the second planetary stage 200 are fixed. The sun gear hollow shaft 30 assigned to the first sun gear 3 is connected to a plane 91 of the planet carrier 9 of the second planetary stage 200, while the second sun gear hollow shaft 40 assigned to the second sun gear 4 is connected to a hub 94 of the planet carrier 9 of the second planetary stage 200. Thus, the rotational movements of the two sun gear hollow shafts 30, 40 on the planet carrier 9 of the second planetary stage 200 are merged.

The two planetary gears 110, 120 connected in parallel are flexibly coupled by way of the common ring gear 2 and the common planet carrier 9 of the second planetary stage 200. The control of the power flow by means of power-splitting planetary gear trains 110, 120 connected in parallel takes place by coordinating the torsional stiffness of the individual components of the planetary gear trains. Individual components worth considering here, inter alia, are: Primarily: hollow shafts 30, 40 of the suns, flexible planetary axles 7, flexible couplings, planet carriers 9 of a downstream planetary stage 200 and its planetary axle 13. Secondarily: planets 5, 6 and ring gears 2.

By appropriately selecting the torsional stiffness of this and, if applicable, other components, power splitting of the torque applied at the inlet of the gearbox, i.e. on the hollow hub on the drive side, can be controlled.

The torsional stiffness of the individual components of the planetary gear trains can, for example, be adjusted by varying wall thicknesses, axial lengths, diameters and the material of the individual components to a desired value.

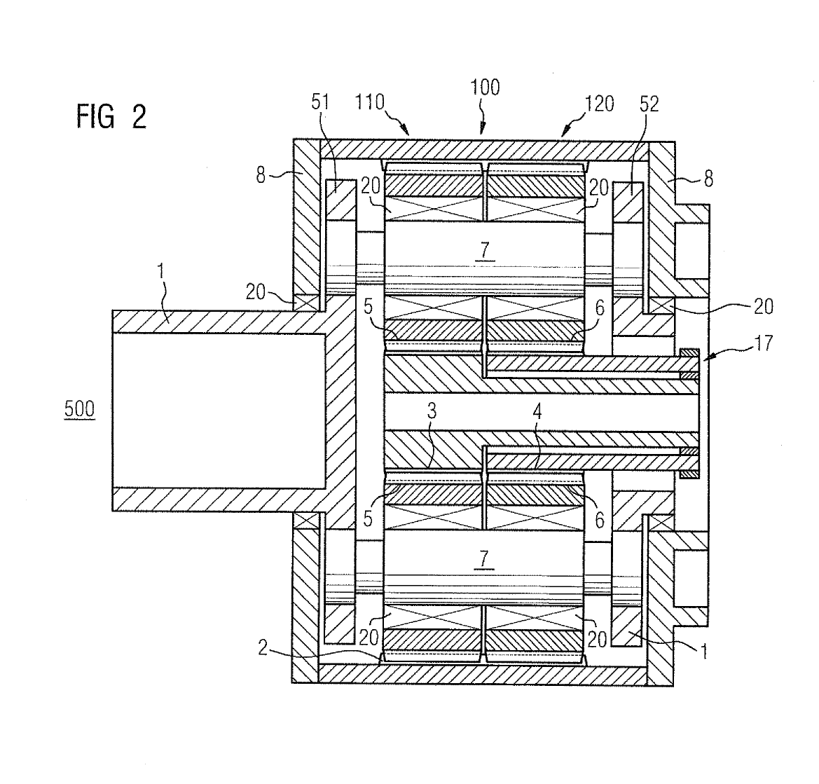

FIG. 2 shows a longitudinal section of a second embodiment of a gearbox according to the present invention. Parts corresponding with those in FIG. 1 are denoted by identical reference numerals and not explained again. The gearbox of FIG. 2 includes a first planetary stage 100 which is essentially designed in the same way as the first planetary stage of the gearbox shown in FIG. 1. In this embodiment, the sun gear hollow shafts 30, 40 at the interface 17 to a downstream component, for example, a second planetary stage, are directly interlinked, whether rigidly, for example, by means of a welded joint or screw connection, or positively, for example, by means of a tooth coupling, or flexibly, for example, by means of an elastomer coupling.

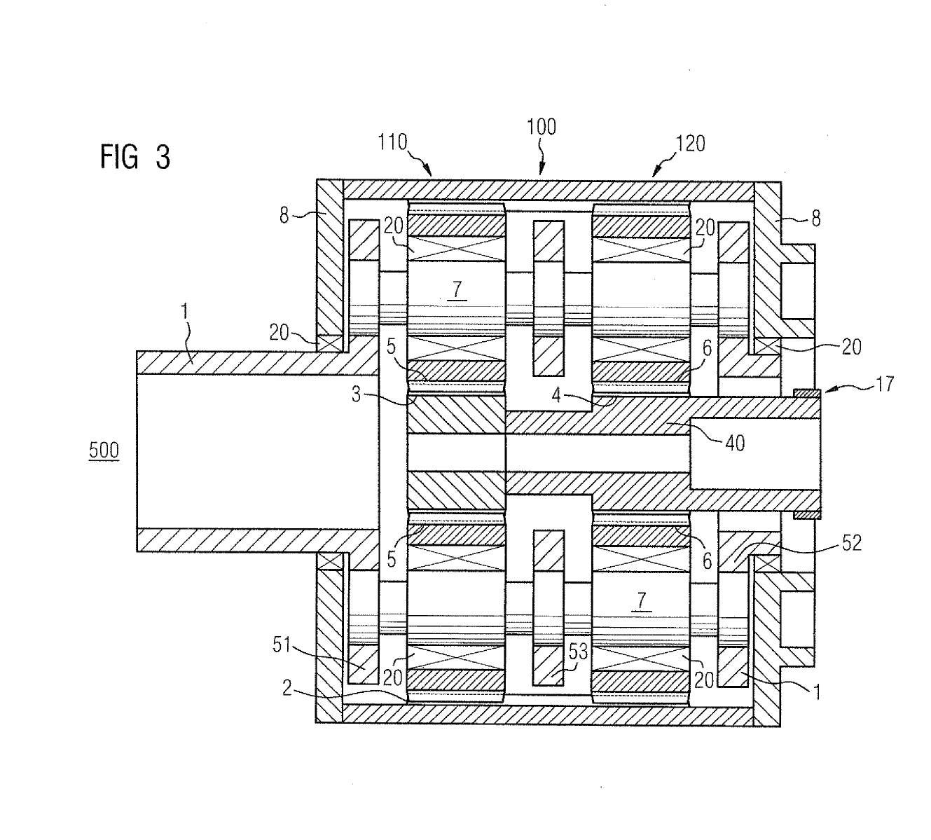

FIG. 3 shows a longitudinal section of a third embodiment of a gearbox according to the present invention. Parts corresponding with those in FIG. 1 are denoted by identical reference numerals and not explained again. The description below will center on the differences between the embodiments. In this embodiment, provision is made for a planet carrier 1 which has three planes: there are hollow hubs in both the planes 51, 52 at the ends, as in the case of the planet carrier shown in FIG. 1, which are used to accommodate the planet carrier in the housing 8 and to fasten the planetary axle 7. The third plane 53 arranged between them is used for the additional radial support of the extended planetary axle 7. By extending the planetary axle 7, the effect of the torsional stiffness of the planetary axle 7 is stronger: in this way, the torsional stiffness of the two parallel power paths through the gearbox can be better controlled by the planetary axle 7. Furthermore, the gearbox of FIG. 3 provides an improved clamping option for the planetary axles.

Instead of being continuous, the planetary axle 7 can also be bipartite in design, i.e. divided in the central plane 53. In this case, the planetary axle 7 has a less stiffening effect on the planet carrier 1/planetary axle 7 subsystem than in a continuous version.

In addition, in the case of the gearbox shown in FIG. 3, the first sun gear 3 of the first planetary stage 100 is axially coupled to the second sun gear 4 of the first planetary stage 100. In this way, the sun gear hollow shaft 30 assigned to the first sun gear 3 is omitted and only the sun gear hollow shaft 40 assigned to the second sun gear 4 is routed to a downstream component at the interface 17.

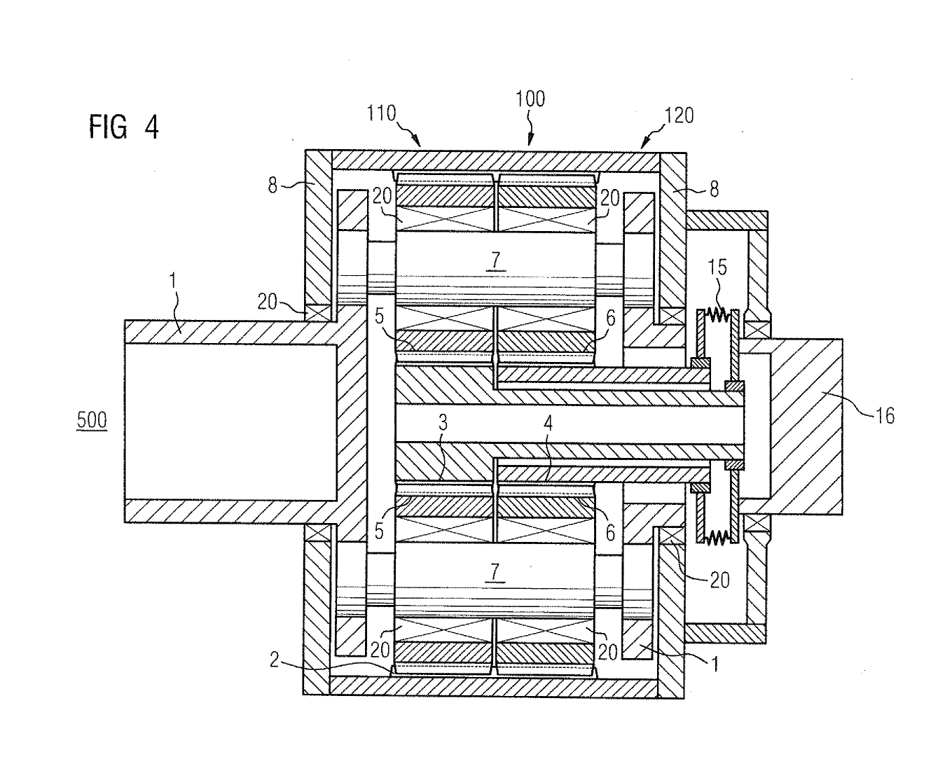

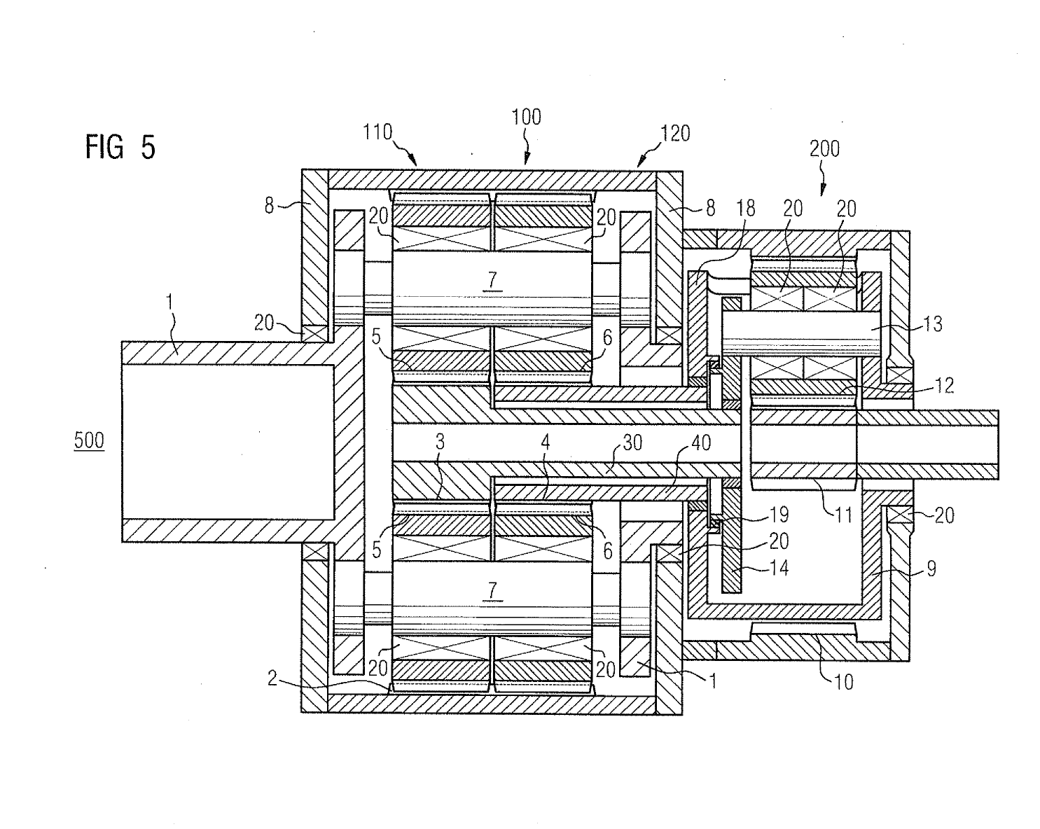

FIG. 4 shows a longitudinal section of a fourth embodiment of a gearbox according to the present invention. The gearbox of FIG. 5 includes a first planetary stage 100 which is essentially designed in the same manner as the first planetary stage of the gearbox shown in FIG. 1. Parts corresponding with those in FIG. 1 are again denoted by identical reference numerals and not explained again. The description below will center on the differences between the embodiments. In this embodiment, provision is made for sun gear hollow shafts 30, 40 which are connected to each other on their output side by means of a clutch 15 and to a connecting element 16 downstream of the first planetary stage 100. By means of the additional clutch 15, the torsional stiffness of the two parallel power paths can also be coordinated by the gearbox.

Coordination can be realized by using numerical simulation: the clutch, just like the sun gear and the planet carrier, has a specific stiffness which is selected such that the required load distribution is adjusted. Coordination in the design phase advantageously takes place by means of numerical simulation. The inspection of the load distribution advantageously takes place by means of deformation measurements at an appropriate point in both load paths under load. Variations in the load distribution can be compared by means of stiffness modification of one or more parts through mechanical removal of material.

FIG. 5 shows a longitudinal section of a fifth embodiment of a gearbox according to the present invention. The gearbox of FIG. 5 includes a first planetary stage 100 and a second planetary stage 200 which is essentially designed in the same manner as the planetary stages of the gearbox shown in FIG. 1. Parts corresponding with those in FIG. 1 are again denoted by identical reference numerals.

The sun gear hollow shafts 30, 40 are routed to a housing outlet where they are rigidly connected to a planet carrier 9 of a second planetary stage 200 in which planetary axles 13 of the second planetary stage 200 are fastened, on which one respective planetary gear 12 of the second planetary stage is mounted so as to rotate, which meshes with a ring gear 10 of the second planetary stage and a sun gear 11 of the second planetary stage. A sun gear hollow shaft assigned to the sun gear 11 forms the output of the gearbox.

An essential difference to the gearbox shown in FIG. 1 is that the sun gear hollow shaft 30 assigned to the first sun gear 3 is connected to an internal plane 14 on the drive side of the planet carrier of the second planetary stage and the sun gear hollow shaft 40 assigned to the second sun gear 4 to an external plane 18 on the drive side of the planet carrier of the second planetary stage. The two planes 14, 18 on the drive side of the planet carrier of the second planetary stage are mounted so as to rotate in relation to each other by means of a swivel bearing 19.

As a result of the division of the plane on the drive side of the planet carrier 9 of the second planetary stage 200 into an internal plane 14 and an external plane 18, it is possible to coordinate the torsional stiffness of the internal load path with the hollow shaft 30 together with the internal planet carrier plane 14 relative to the torsional stiffness of the external load path with the hollow shaft 40 together with the external plane 18. The torsion/twisting stiffness of the elements 14, 18, 30 and 40 concerned must be selected such that the right and left fixing point of the planetary axle 13 in the planes of the planet carrier 09 experiences the desired displacement in a tangential direction.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A gearbox, comprising a planetary stage including at least two planetary gear trains connected in parallel and flexibly coupled to one another, each said planetary gear train having individual components which are each defined by a torsional stiffness, with a power flow through the planetary gear trains being controlled by coordinating the torsional stiffness of the individual components of the planetary gear trains.

2. The gearbox of claim 1, wherein the planetary stage includes a planet carrier, a planetary axle fastened in the planet carrier, at least two planetary gears mounted on the planetary axle for rotation independently of each other, ring gears meshing with the planetary gears in one-to-one correspondence, and sun gears meshing with the planetary gears in one-to-one correspondence, each said sun gear arranged in a torque-proof manner on a sun gear shaft.

3. The gearbox of claim 2, wherein the sun gear shaft of one of the sun gears and the sun gear shaft of another one of the sun gears are arranged coaxially relative to one another.

4. The gearbox of claim 2, wherein the ring gears are rigidly interconnected with one another.

5. The gearbox of claim 4, wherein the ring gears are made in one piece.

6. The gearbox of claim 2, wherein the sun gear shaft of one of the sun gears and the sun gear shaft of another one of the sun gears are flexibly interconnected.

7. The gearbox of claim 2, further comprising a clutch for flexibly interconnecting the sun gear shaft of one of the sun gears and the sun gear shaft of another one of the sun gears.

8. The gearbox of claim 2, wherein the planetary axle has a center which is fastened in the planet carrier, said at least two planetary gears being located on the planetary axle on both sides of the center.
